(19) United States
(12) Patent Application Publication
(10) Pub. No.: US 2012/0133108 A1
(43) Pub. Date: May 31, 2012

(54) VEHICLE HAVING AT LEAST TWO WHEELS AND A SUSPENDED FRAME, AND EQUIPPED WITH A CARRIER ASSEMBLY

(75) Inventors: Stéphane Dassonneville, Bondues (FR); Benoit Carrelet, Lille (FR); Bruno Weulersse, Lille (FR)

(73) Assignee: DECATHLON, Villeneuve D'Ascq (FR)

(21) Appl. No.: 13/376,948

(22) PCT Filed: Jun. 8, 2010
(86) PCT No.: PCT/FR10/51133

§ 371 Date: Feb. 8, 2012

(30) Foreign Application Priority Data
Jun. 8, 2009 (FR) 0953779

(51) Int. Cl. B62K 25/12

(52) U.S. Cl. 280/284

(57) ABSTRACT

The invention relates to a vehicle having at least two wheels and having a suspended frame, with a carrier assembly designed, in particular, to perform a luggage rack or child seat carrier function. The vehicle includes a front chassis, a rockable rear assembly carrying a driving rear wheel, secured to the chassis via a shock-absorber system and hinged to said chassis about a first pivot point, and a carrier assembly comprising a carrier element having a front end and a rear end, and a support element having a top end and a bottom end. The front end of said carrier element is connected to the chassis, and its rear end is hinged to said top end of said support element about a second pivot point. The bottom end of the support element is hinged to the rockable rear assembly about a third pivot point. During compression of the shock-absorber system, the support element goes from a position in which the third pivot point is situated on a first side of the axis passing through the other two pivot points, to a position in which said third pivot point is situated on a second side of the axis, so that all three pivot points are substantially aligned at at least one stage of compression of the shock-absorber system.

This is a 371 national phase application of PCT/FR2010/051133 filed 08 Jun., 2010, claiming priority to

French Patent Application No. 0953779 filed 08 Jun., 2009, the contents of which are incorporated herein by reference.

### FIELD OF THE INVENTION

The present invention relates to a vehicle having at least two wheels, such as a bicycle, e.g., of the mountain bike type. More precisely, the invention relates to such a vehicle that has a suspended frame, and that is equipped with a carrier assembly designed, in particular, to perform a luggage rack function or a child seat carrier function.

### BACKGROUND OF THE INVENTION

A “bicycle having a suspended frame” is a vehicle having a frame that is made up of a front portion or front chassis carrying, in particular, the front wheel, and of a rear portion or “rockable rear assembly” that is distinct from the front portion, that carries the rear wheel and that is connected in suspended manner to the front chassis.

Conversely, a bicycle that is not equipped with a suspended frame is equipped with a rigid frame with no freedom of movement between the rear portion carrying the rear wheel and the front portion carrying the front wheel.

Various bicycle-mounted carrier systems are known. Conventional luggage rack or child seat systems are generally ill-suited to bicycles having suspended frames.

Regulatory constraints preclude relative movement between the saddle and the child, and require a minimum distance to be maintained between the saddle and the body of the child for safety reasons.

Such regulatory constraints are easy to accommodate when designing a bicycle having a rigid frame.

By way of example, it is thus possible to use an intermediate plate that comes to be fastened onto the luggage carrier and under the child seat, and that is also secured to the frame. Such a plate, correctly fastened and of appropriate dimensions, makes it possible to maintain the regulatory distance between the saddle and the body of the child. In addition, the rigidity of the frame and the rigidity of the fastening between the various elements. (luggage carrier, plate, child seat, and frame) prevents any relative movement between the saddle and the child.

On a bicycle having a suspended frame, it is necessary to take account of the absence of rigidity between the front portion of the frame that carries, in particular, the saddle, and the rear portion of the frame that carries, in particular, the child.

Solutions are known in which the carrier element of the luggage rack is connected to the saddle tube and supported directly by one of the frame members of the front chassis. The luggage carrier is thus directly integrated into the frame of the bicycle, constituting an extension to one of the frame members of the front chassis. This applies, for example to the solution described in Document WO 00/43258.

The direct coupling between the luggage rack and the front chassis, with no coupling to the rockable rear assembly, makes it possible, in particular to avoid any relative movement between the luggage rack and the saddle.

However, such a solution increases the weight of the bicycle and its manufacturing cost.

Solutions are also known such as those described in Documents EP 1 069 034 and DE 200 15 126 U.

Each of the bicycles described in those documents has a suspended frame and a carrier assembly. The carrier assembly is connected via its front portion to the front chassis of the frame, at the saddle tube, and is hinged via its rear end to the rockable rear assembly of the frame via a coupling strut.

However, such solutions do not guarantee that the carrier element of the carrier assembly that is designed to receive luggage or a child seat does not move vertically or moves vertically to only a very small extent. Unfortunately, vertical movement of the carrier element, while the bike is being used, can cause damage to the luggage carried when said luggage is fragile. In addition, when a child is to be carried in a child seat, such vertical movement gives rise to discomfort that limits potential journey times.

### SUMMARY OF THE INVENTION

An object of the invention is thus to provide a solution to the above-mentioned problems, among other problems.

To this end, the invention provides a vehicle having at least two wheels, in particular a bicycle, having a front chassis and a rockable rear assembly.

The rockable rear assembly carries a driving rear wheel. It is secured to the front chassis via a shock-absorber system, and also hinged to said front chassis about a first pivot point.

The vehicle also has a carrier assembly comprising a carrier element and a support element.

The carrier assembly has a front end and a rear end, and the support element has a top end and a bottom end.

The front end of the carrier element is connected to the front chassis, and its rear end is hinged to the top end of the support element about a second pivot point.

In addition, the bottom end of the support element is hinged to the rockable rear assembly about a third pivot point.

In characteristic manner, the carrier assembly and the rockable rear assembly are arranged so that, during compression of the shock-absorber system, the support element goes from a position in which the third pivot point is situated on a first side of the axis passing through the first and second pivot points to a position in which said third pivot point is situated on a second side of the axis passing through said first and second pivot points, so that said first, second and third pivot points are substantially aligned at at least one stage of compression of the shock-absorber system.

Thus, by guaranteeing that the first, second, and third pivot points are aligned at at least one stage of compression of the shock-absorber system, it is guaranteed that at least at this stage of compression and within a range of compression that surrounds this stage of compression, the second pivot point undergoes very little or no vertical movement. Therefore, within this range of compression, the carrier element of the carrier assembly undergoes very little or no vertical movement, thereby making luggage carriage feel safer, and making child carriage more comfortable.

Several variants are presented below and they may be considered on their own or in combination with one or more others.

The first, second, and third pivot points are substantially aligned at at least one stage of compression of the shock-absorber system lying in the range 50% of its maximum stroke to 70% of its maximum stroke and/or lying in the range 40% of its working stroke to 60% of its working stroke.

The “maximum stroke” of the shock-absorber system corresponds to the stroke of the shock absorber between the rest position as unloaded, i.e. without any load on the vehicle and thus without any compression of the system, and the position of maximum compression of the system.

The “working stroke” of the shock-absorber system corresponds to the stroke of the shock-absorber system between the rest position as loaded, i.e., with a certain load on the vehicle and thus with the system starting to be compressed, and the position of maximum compression of the system.

The phrase “load on the vehicle” means the load constituted by the rider using the vehicle plus any load carried on the carrier assembly such. as luggage or a child.

The front chassis includes a saddle tube, and the front end of the carrier element is connected to the chassis at said saddle tube.

The front end of the carrier element is hinged to the front chassis about a fourth pivot point.

The rockable rear assembly includes an upper stay, and the bottom end of the support element is connected to the rockable rear assembly at said upper stay.

The shock-absorber system has a front end connected to the front chassis and a rear end connected to the rockable rear assembly.

The coupling between the front end of the shock-absorber system and the front chassis is a hinge-coupling, preferably at the saddle tube.

The coupling between the rear end of the shock-absorber system and the rockable rear assembly is a hinge-coupling, preferably at the front end of the upper stay.

During compression of the shock-absorber system, the second pivot point shifts vertically by a maximum distance of 0.5 millimeters (mm) relative to its position when said shock-absorber system is at rest.

This shift is measured as unloaded, i.e., without any load on the vehicle, and/or with a certain load corresponding to the weight of the rider user, plus the weight of any load carried on the carrier assembly such as luggage or a child.

### BRIEF DESCRIPTION OF THE DRAWINGS

Other characteristics and advantages of the invention appear more clearly and fully on reading the following description of preferred variant embodiments, given by way of non-limiting examples, and with reference to the accompanying drawings, in which:

FIGS. 1A, 1B, 1C are diagrams showing the linkage of a first example of a vehicle respectively at 0%, 50%, and 100% compression of the shock-absorber system;

FIG. 2 is a diagram showing the linkage of the first example of a vehicle of the invention; with the three respective configurations at 0%, 50%, and 100% compression of the shock-absorber system being superposed;

FIG. 3 is a diagram showing the linkage of a second example of a vehicle of the invention; and

FIG. 4 is a diagram showing the linkage of a third example of a vehicle of the invention.

### DETAILED DESCRIPTION

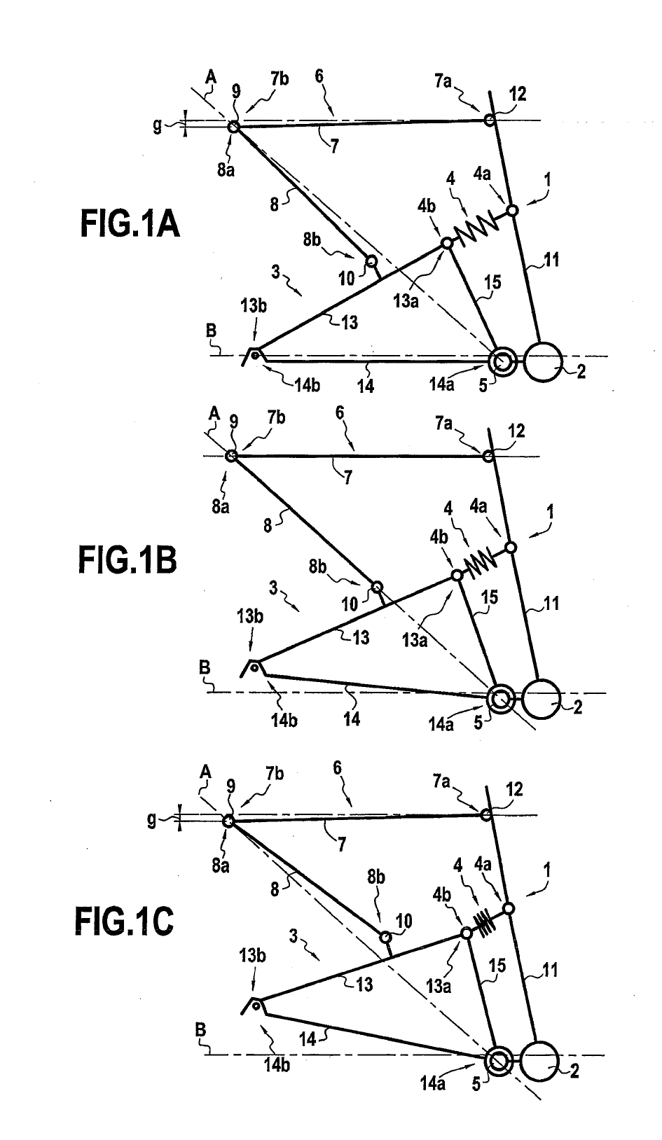

FIGS. 1A, 1B, 1C are diagrams showing the linkage of a vehicle of the invention, e.g., of the bicycle type, in a first embodiment.

In this embodiment, the suspended-type frame includes a front portion 1 or front chassis 1, with only the substantially vertical element 11 of said front chassis being shown, which element corresponds to the saddle tube 11. This front chassis is designed, in particular, to carry the front wheel of the bicycle.

In this embodiment, the front chassis 1 carries a crankset 2.

The suspended frame also includes a rockable rear assembly 3 designed to carry a driving rear wheel.

This rockable rear assembly 3 is connected to the front chassis 1 firstly via a shock absorber system 4 and secondly via a first pivot point 5.

In this embodiment, the rockable rear assembly 3 includes an upper stay 13 that extends from the axis of the rear wheel, at its rear end 13b, to the coupling point at which it is coupled to the shock-absorber system 4, at its front end 13a.

The rockable rear assembly 3 also includes a frame member 15 that extends from the front end 13a of the upper stay 13 to. the first pivot point 5.

In this embodiment, the first pivot point 5 is situated at the crankset 2 carried by the front chassis 1, at the bottom of the saddle tube 11.

Finally, the rockable rear assembly 3 includes a lower-stay element 14 that extends from its rear end 14b to its front end 14a, between the rear end 13b of the upper stay 13 and the first pivot point 5.

The shock-absorber system 4 has a rear end 4b hinged to the front end 13a of the upper stay 13, and a rear end 4a hinged to the front chassis 1, at the saddle tube 11.

In addition, the bicycle is provided with a carrier assembly 6 comprising a carrier element 7 and a support element 8.

The carrier element 7 is designed to receive a load, such as luggage or a child seat. When the load is constituted by a child seat, the carrier element 7 may be an integral part of the child seat. In other words, one of the elements of the child seat is then assembled directly to the vehicle so as to constitute the carrier element 7.

This carrier element 7 extends substantially horizontally from its rear end 7b to its front end 7a where it is connected to the front chassis 1, preferably by being hinged thereto at a fourth pivot point 12, at the saddle tube 11.

The support element 8 extends from its top end 8a to it bottom end 8b, between the rear end 7b of the carrier element 7 and the rockable rear assembly 3.

The coupling between the rear end 7b of the carrier element 7 and the top end 8a of the support element 8 is a hinge-coupling at a second pivot point 9.

The coupling between the bottom end 8b of the support element 8 and the rockable rear assembly 3 is a hinge-coupling at a third pivot point 10. This coupling between the support element 8, via its bottom end 8b, and the rockable rear assembly 3 takes place at the upper stay 13.

FIG. 1A shows the vehicle at rest, in a loaded configuration, i.e., with the shock-absorber system 4 beginning to be compressed due to the weight of the user on the bike and to the weight of any load carried on the carrier assembly. FIG. 1B shows the vehicle in use, in a configuration loaded to 50% of the working compression stroke of the shock-absorber system 4. Finally, FIG. 1C shows the vehicle in use, in a configuration loaded to 100% of the compression stroke of the shock-absorber system.

It can be seen that the carrier assembly 6 and the rockable rear assembly 3 are such that the first pivot point 5, the second pivot point 9, and the third pivot point 10 are aligned along the axis A, at a stage of compression of the shock-absorber system corresponding to 50% of its working stroke (FIG. 1B).

The rockable rear assembly 3 rocks as a function of the compression of the shock-absorber system 4.

Thus, the axis of the rear wheel, corresponding to the intersection between the lower-stay element 14 and the upper stay 13, moves vertically during compression of the shock-absorber system 4, by a distance dl (FIG. 1B: compression to 50% of the working stroke of the shock-absorber system 4), and d2 (FIG. 1C: compression to 100% of the working stroke of the shock-absorber system 4).

In addition, during compression of the shock-absorber system 4, the third pivot point 10 rocks from one side to the other of the axis A passing through the first and second pivot points 5 and 9, so that the three pivot points 5, 9, and 10 find themselves aligned at one stage of compression of the shock-absorber system 4.

In a preferred embodiment, this alignment of the three pivot points 5, 9, and 10 is obtained within a compression range from 40% to 60% of the working compression stroke of the shock-absorber system, corresponding approximately to a compression range of 50% to 70% of the maximum compression stroke of said shock-absorber system 4.

In the embodiment shown. in FIGS. 1A, 1B, and 1C, and more precisely with reference to FIG. 1B, the stage of compression at which the three pivot points 5, 9, and 10 are in alignment corresponds substantially to the shock-absorber system 4 being compressed to 50% of the working compression stroke.

In addition, the rear end 7b of the carrier element 7 of the carrier assembly 6, corresponding to the second pivot point 9 shifts vertically, during compression of the shock-absorber system 4, by a very short distance g, of the order of a few millimeters (e.g., a maximum of 0.5 mm) in a preferred variant embodiment).

By means of this configuration, the luggage or the person carried on the carrier assembly 6 is subjected to only a very small extent to the vertical movements resulting from compression of the shock-absorber system 4, this compression in turn resulting from the configuration of the ground on which the bicycle is traveling.

In practice, when designing the vehicle, provision is made for it to be adapted for people lying within a certain weight category, and for carrying a load of up to a given maximum weight on the carrier assembly.

Thus, for a given vehicle, the concept of “loaded configuration” corresponds to a configuration in which the vehicle's load is constituted by a rider user, of weight lying within the weight category for which the vehicle is designed, plus any load carried by the carrier assembly and of weight not exceeding the given maximum weight.

In order to achieve this adaptation, it is possible to act on the unloaded setting of the compression system, on the stiffness of the compression element when the compression system includes such an element (e.g., a spring), on the dimensions of the various elements of the structure of the vehicle, in particular of the rockable rear assembly and of the carrier assembly, and on the positions of the hinge-coupling points.

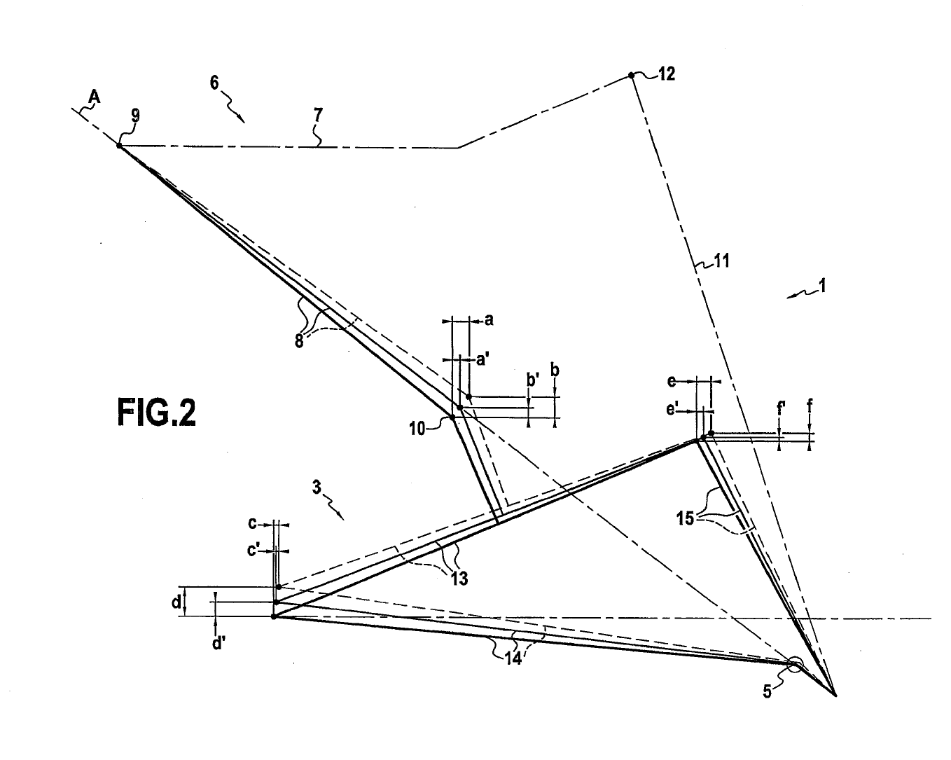

FIG. 2 is a diagram showing the relative movements of the linkage, by showing the vehicle at three stages of compression of the shock-absorber system 4 corresponding respectively to 0%, 50%, and 100% of the working compression stroke of said shock-absorber system 4.

More precisely, the elements for which shifting is shown are shown in thick continuous lines for the 0% compression stage, in fine continuous lines for the 50% compression stage, and in dashed lines for the 100% compression stage.

FIG. 2 shows the same structural elements of the suspended frame as those referenced in FIGS. 1A, 1B, 1C, and they thus bear the same numerical references.

Thus, when the shock-absorber system (not shown in FIG. 2 for reasons of clarity) goes from the rest position as loaded, i.e., 0% working compression, to the position in which it is compressed to 50% of the working compression stroke, the rockable rear assembly 3 shifts.

In the embodiment shown in FIG. 2:
the point corresponding to the axis of the rear wheel (intersection of the upper stay 13 and of the lower-stay element 14) shifts vertically by a distance d′ of 13.4 mm, and horizontally by a distance c′ of 2.1 mm;
the point corresponding to the intersection of the seat stay 13 and of the frame member 15 shifts vertically by a distance f′ of 3.3 mm, and horizontally by a distance e′ of 6.2 mm; and
the third pivot point 10 shifts vertically by a distance b′ of 9.1 mm, and horizontally by a distance a′ of 6.8 mm.

This shifting of the rockable rear assembly 3 generates almost no shift in the carrier element 7 of the carrier assembly 6. Thus, in the embodiment shown in FIG. 2, going from 0% to 50% of the working compression stroke of the shock-absorber system causes-the second pivot point 9 to shift vertically by about 0.4 mm, and in any event by less than 0.5 mm.

In addition, when the shock-absorber system goes from the rest position, as loaded, i.e., with 0% of working compression, to the position in which it is compressed to 100% of the working compression stroke, the rockable rear assembly 3 shifts.

In the embodiment shown in FIG. 2:
the point corresponding to the axis of the rear wheel (intersection of the upper stay 13 and of the lower-stay element 14) shifts vertically by a distance d of 27.5 mm, and horizontally by a distance c of 4.7 mm;
the point corresponding to the intersection of the upper stay 13 and of the frame member 15 shifts vertically by a distance f of 6.6 mm, and horizontally by a distance e of 12.9 mm;
the third pivot point 10 shifts vertically by a distance b of 18.5 mm, and horizontally by a distance e of 14.4 mm.

This shifting of the rockable rear assembly 3 also generates almost no shift in the carrier element 7 of the carrier assembly 6. Thus, in the embodiment shown in FIG. 2, going from 0% to 100% of the working compression stroke of the shock-absorber system causes the second pivot point 9 to shift vertically by about 0.1 mm, and in any event less than 0.5 mm.

In practice, the stage of compression of the shock-absorber system 4 at which the three pivot points 5, 9, and 10 are aligned corresponds substantially to the maximum vertical shift g of the second pivot point 9.

Thus, this vertical shift g of the second pivot point 9 increases from 0 mm or 0.1 mm to a few tenths of a millimeter (less than 0.5 mm in the embodiment corresponding to FIGS. 1A, 1B, 1C, and 2), when the shock-absorber system 4 goes from a stage of compression corresponding to 0% of the working compression stroke to a stage of compression corresponding to 50% of the working compression stroke.

Then, this vertical shift g of the second pivot point 9 decreases from a few tenths of a millimeter (less than 0.5 mm in the embodiment corresponding to

FIGS. 1A, 1B, 1C, and 2) substantially to 0 or 0.1 mm, when the shock-absorber system 4 goes from a stage of compression corresponding to 50% of the working compression stroke to a stage of compression corresponding to 100% of the working compression stroke.

This is what is shown in Table T and in Graph G below. Table T gives the values in mm for the shift g in the second pivot point 9 (in the right column) as a function of the values in percent for the compression of the working compression stroke of the shock absorber system (in the left column).

These values are shown graphically in Graph G, with the values in percentage for the compression of the working compression stroke of the shock-absorber system being plotted along the x-axis, and the values in mm for the shift g of the second pivot point 9 being plotted up the y-axis.

TABLE T

| Compression | Vertical shift of the |
|---|---|
| in % | second pivot point 9 in mm |
| 0 | 0 |
| 5 | 0.08 |
| 10 | 0.16 |
| 15 | 0.23 |
| 20 | 0.29 |
| 25 | 0.34 |
| 30 | 0.39 |
| 35 | 0.42 |
| 40 | 0.45 |
| 45 | 0.46 |
| 50 | 0.47 |
| 55 | 0.46 |
| 60 | 0.45 |
| 65 | 0.42 |
| 70 | 0.39 |
| 75 | 0.34 |
| 80 | 0.29 |
| 85 | 0.23 |
| 90 | 0.16 |
| 95 | 0.08 |
| 100 | 0 |

In order to measure the various shifts presented above while the shock-absorber system is being compressed, and in order to measure the alignment of the three pivot points at a certain stage of compression of the shock-absorber system, it suffices to apply a certain load to the vehicle.

Such a load can be applied, for example, by placing a load on the saddle of the bike and possibly a load on the carrier assembly, and thus by indirectly compressing the shock-absorber system.

It is also possible to compress the shock-absorber system directly by exerting action directly thereon by using a suitable machine or tool.

Thus, it is possible to take the measurements throughout the maximum stroke of the shock-absorber system, starting from the rest position, without any load, and by applying load artificially and progressively by directly or indirectly compressing the shock-absorber system.

It is also possible to take such measurements throughout the working stroke of the shock-absorber system. Prior to taking the measurements, a load corresponding to the weight of a rider user is then placed on the vehicle, and possibly a load corresponding to the weight of luggage or of a child carried on the carrier assembly is then placed on the vehicle. Then, starting from this position, load is applied artificially and progressively by directly or indirectly compressing the shock-absorber system.

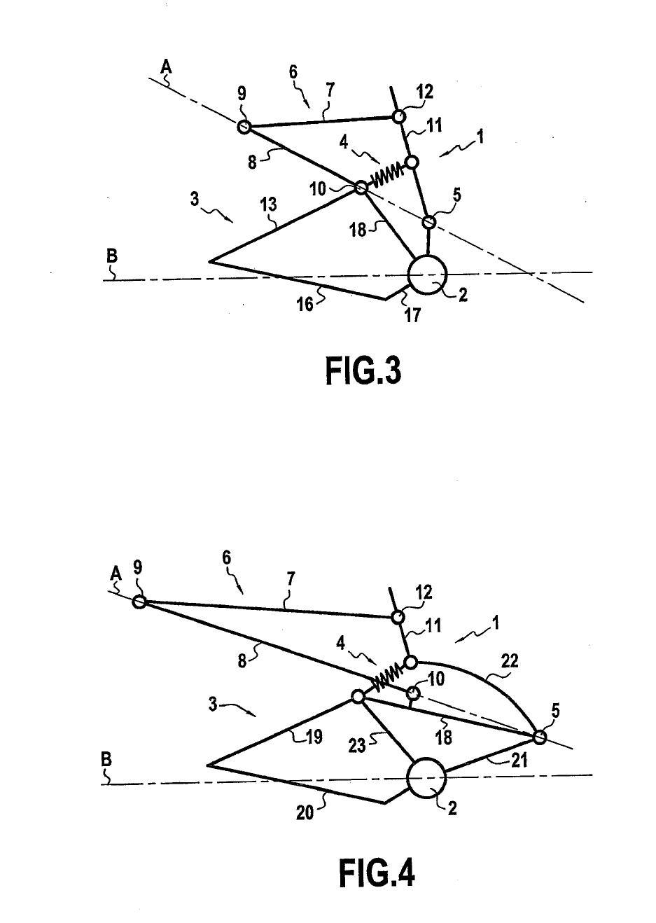

FIGS. 3 and 4 correspond to kinetic diagrams of a vehicle of the invention, e.g., of the bicycle type, in two other embodiments, in which the structure of the suspended frame differs relative to the structure shown in FIGS. 1A, 1B, 1C, and 2.

Thus, in FIGS. 3 and 4, the crankset 2 is not carried by the front chassis 1 but rather it is carried by the rockable rear assembly 3, and the vehicle is shown with the shock-absorber 4 compressed at 50% of its working compression stroke.

The three pivot points 5, 9, and 10 are thus aligned in this position.

In addition, in the example shown in FIG. 3, the lower-stay element of the rockable rear assembly 3 is made up of two frame members 16 and 17 that extend between the axis of the rear wheel (and thus the bottom end of the upper stay 13) and the crankset 2.

The rockable rear assembly 3 is connected to the front chassis 1 at a first pivot point 5, at said crankset 2.

In addition, the rockable rear assembly 3 is connected to the front chassis 1, e.g., at the saddle tube 11, via the shock-absorber system 4. The hinge-coupling point between the rockable rear assembly 3, at the front end of the upper stay 13, and the shock-absorber system 4, is the same as the third pivot point 10, i.e., the hinge point at which the support element 8 of the carrier assembly 6 is hinged to the rockable rear assembly 3.

In the example shown in FIG. 4, the structure of the rockable rear assembly 3 differs in that the crankset 2 is carried between two substantially triangular structures having three frame members, with one of the frame members being a common one.

Thus, the crankset is disposed at the bottom end of a first triangular structure 18, 21, 23 and at the front end of a second triangular structure 19, 20, 23.

The first pivot point 5, forming a hinge-coupling between the rockable rear assembly 3 and the front chassis 1, is situated at the front end of the first triangular structure 18, 21, 23.

The shock-absorber system 4 also connects together the rockable rear assembly 3 and the front chassis 1, in particular via a hinge-coupling at the top end of the second triangular structure 19, 20, 23 that is also the rear end of the first triangular structure 18, 21, 23.

In addition, the support element 8 of the carrier assembly 6 is hinged, via its bottom end, to the upper frame member 18 of the first triangular structure 18, 21, 23, at the third pivot point 10.

The front chassis 1, shown in fragmentary manner, includes, in particular, the saddle tube 11 that is extended in the form of a frame member 22 between firstly the hinge-coupling point at which the shock-absorber system 4 is hinged to the front chassis 1 and secondly the first pivot point 5.

The present description is given by way of example, and is therefore not limiting on the invention.

In particular, the exact structures of the front chassis 1 and of the rockable rear assembly 3 as presented in this description are not limiting. Other embodiments are possible, provided that the three pivot points 5, 9, and 10 are kept in alignment at at least one stage of compression of the shock-absorber system 4, this stage of compression lying preferably at or around 50% of the working compression stroke of said shock-absorber system 4.

1. A vehicle having at least two wheels, in particular, a bicycle, having:
a front chassis;
a rockable rear assembly carrying a driving rear wheel, secured to said front chassis via a shock-absorber system, and also hinged to said front chassis about a first pivot point;
a carrier assembly comprising a carrier element having a front end and a rear end, and a support element having a top end and a bottom end, said front end of said carrier element being connected to the front chassis, said rear end of said carrier element being hinged to said top end of said support element about a second pivot point, said bottom end of said support element being hinged to the rockable rear assembly about a third pivot point;
wherein the carrier assembly, the rockable rear assembly and the shock-absorber system are arranged so that, during compression of the shock-absorber system, the support element goes from a position in which the third pivot point is situated on a first side of the axis passing through the first and second pivot points to a position in which said third pivot point is situated on a second side of the axis passing through said first and second pivot points, so that said first, second and third pivot points are substantially aligned at at least one stage of compression of said shock-absorber system.

2. A vehicle according to claim 1, wherein the first, second, and third pivot points are substantially aligned at at least one stage of compression of the shock-absorber system lying in the range of 50% of its maximum stroke to 70% of its maximum stroke and/or lying in the range of 40% of its working stroke to 60% of its working stroke.

3. A vehicle according to claim 1, wherein the front chassis includes a saddle tube, and in that the front end of the carrier element is connected to said front chassis at said saddle tube.

4. A vehicle according to claim 1, wherein the front end of the carrier element is hinged to the front chassis about a fourth pivot point.

5. A vehicle according to claim 1, wherein the rockable rear assembly includes an upper stay, and the bottom end of the support element is connected to said rockable rear assembly at said upper stay.

6. A vehicle according to claim 1, wherein the shock-absorber system has a front end connected to the front chassis and a rear end connected to the rockable rear assembly.

7. A vehicle according to claim 6, wherein the coupling between the front end of the shock-absorber system and the front chassis is a hinge-coupling, preferably at the saddle tube.

8. A vehicle according to claim 6, wherein the coupling between the rear end of the shock-absorber system and the rockable rear assembly is a hinge-coupling, preferably at the front end of the upper stay.

9. A vehicle according to claim 1, wherein, during compression of the shock-absorber system, the second pivot point shifts vertically by a maximum distance of 0.5 mm relative to its position when said shock-absorber system is at rest.
